(19) United States
(12) Patent Application Publication
(10) Pub. No.: US 2024/0346074 A1
(43) Pub. Date: Oct. 17, 2024

(54) VIDEO FINDING USING DISTANCE-BASED HASH MATCHING

(71) Applicant: Magnet Forensics Inc., Waterloo (CA)

(72) Inventor: Christopher Sippel, Kitchener (CA)

(21) Appl. No.: 18/637,875

(22) Filed: Apr. 17, 2024

Related U.S. Application Data
(60) Provisional application No. 63/496,582, filed on Apr. 17, 2023.

(51) Int. Cl. G06F 16/735; G06F 16/783; G06V 10/74; G10L 15/10

(52) U.S. Cl. CPC G06F 16/735; G06F 16/7834; G06V 10/761; G10L 15/10

(57) ABSTRACT

Systems and methods for video matching are provided. A video matching method includes receiving known video data comprising a first plurality of video frames and unknown video data comprising a second plurality of video frames, converting all pixel channel values of each video frame into buffer values, calculating a buffer distance value of each pixel of each video frame by comparing buffer values for all pixels of each video frame of the unknown video data to the known video data, and calculating an average buffer distance value, the average buffer distance value comprising the mean value of the buffer distance value of each pixel of all frames.

### TECHNICAL FIELD

The following relates generally to digital forensics and forensic data analysis, and more particularly to systems and methods for video identification using content-based hashing.

### INTRODUCTION

It may be advantageous to identify if the content of a file is similar to another file. Hashing methods, such as MD5 or other methods may be used to generate a hash of two files, comprising a relatively short string of characters, which may then be compared to determine if the two files are identical. Such methods may function well for identical files, however, files that are very similar, but differ slightly, may not be easily matched using such methods.

In forensic contexts, file matching methods are preferably robust to slight differences between files, or intentional attempts to thwart such matching methods. For example, video files may be manipulated, cropped, blurred, adjusted in color, have overlays applied, be compressed and/or converted to a different resolution, bitrate, or file format, which may result in a different file that cannot be easily matched using hashing methods such as MD5.

Content based video hashing methods may allow for video files to be matched by analyzing the content of the video, such as the color and geometry displayed in the constituent frames of the video file. Current content-based video hashing methods can be resource intensive, inefficient, and not robust to intentional deception.

Accordingly, there is a need for an improved system and method for content-based video hashing that overcomes at least some of the disadvantages of existing systems and methods.

### SUMMARY

A video matching method is provided. The method includes: receiving known video data comprising a first plurality of video frames and unknown video data comprising a second plurality of video frames; converting all pixel channel values of each video frame into buffer values; calculating a buffer distance value of each pixel of each video frame by comparing buffer values for all pixels of each video frame of the unknown video data to the known video data; and calculating an average buffer distance value, the average buffer distance value comprising the mean value of the buffer distance value of each pixel of all frames.

The method may further include comparing the average buffer distance value to a distance threshold to generate a video similarity value and using the video similarity value to determine whether the known and unknown videos are deemed to match.

The method may further include comparing a set of matching buffer values to a distance threshold to generate a video similarity value and using the video similarity value to determine whether the known and unknown videos are deemed to match.

The method may further include comparing a percentage of matching buffer values to a distance threshold to generate a video similarity value and using the video similarity value to determine whether the known and unknown videos are deemed to match.

The method may further include calculating a number of matching pixel buffer values for each frame.

The method may further include calculating a mean number of matching pixel buffer values across all frames.

When the average video distance value is less than a threshold buffer distance, the known video data and unknown video data may be deemed to match.

A video matching method is also provided. The method includes: extracting first audio data of known video data and second audio data of unknown video data; generating a first hash of the first audio data and a second hash of the second audio data, each of the first and second hashes comprising a plurality of samples, each sample comprising a high value or low value, wherein high values correspond to loud periods, and low values correspond to quiet periods; comparing the first and second hashes to generate a hash comparison map; calculating an audio hash distance value from the hash comparison map; applying a speech to text algorithm to each of the first audio data and the second audio data to generate a transcript of the first audio data and the second audio data, respectively; comparing the transcript of the first audio data and the transcript of the second audio data to generate a transcript comparison map; and calculating an average transcript distance value from the transcript comparison map.

The method may further include averaging the average transcript distance value and the average buffer distance value to generate an overall similarity value.

A file-based hash method may be used to generate the first hash and the second hash to determine a match between the first audio data and the second audio data.

A computer system for video matching is provided. The system includes at least one processor configured to: receive known video data comprising a first plurality of video frames and unknown video data comprising a second plurality of video frames; convert all pixel channel values of each video frame into buffer values; calculate a buffer distance value of each pixel of each video frame by comparing buffer values for all pixels of each video frame of the unknown video data to the known video data; and calculate an average buffer distance value, the average buffer distance value comprising the mean value of the buffer distance value of each pixel of all frames.

The at least one processor may be further configured to compare the average buffer distance value to a distance threshold to generate a video similarity value and use the video similarity value to determine whether the known and unknown videos are deemed to match.

The at least one processor may be further configured to compare a set of matching buffer values to a distance threshold to generate a video similarity value and use the video similarity value to determine whether the known and unknown videos are deemed to match.

The at least one processor may be further configured to compare a percentage of matching buffer values to a distance threshold to generate a video similarity value and use the video similarity value to determine whether the known and unknown videos are deemed to match.

The at least one processor may be further configured to calculate a number of matching pixel buffer values for each frame.

The at least one processor may be further configured to calculate a mean number of matching pixel buffer values across all frames.

When the average video distance value is less than a threshold buffer distance, the known video data and unknown video data may be deemed to match.

A computer system for video matching is provided. The system includes at least one processor configured to: extract first audio data of known video data and second audio data of unknown video data; generate a first hash of the first audio data and a second hash of the second audio data, each of the first and second hashes comprising a plurality of samples, each sample comprising a high value or low value, wherein high values correspond to loud periods, and low values correspond to quiet periods; compare the first and second hashes to generate a hash comparison map; calculate an audio hash distance value from the hash comparison map; apply a speech to text algorithm to each of the first audio data and the second audio data to generate a transcript of the first audio data and the second audio data, respectively; compare the transcript of the first audio data and the transcript of the second audio data to generate a transcript comparison map; and calculate an average transcript distance value from the transcript comparison map.

The at least one processor may be further configured to method average the average transcript distance value and the average buffer distance value to generate an overall similarity value.

The at least one processor may be further configured to use a file-based hash method to generate the first hash and the second hash to determine a match between the first audio data and the second audio data.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is a schematic diagram of a content-based video hashing process, according to an embodiment;

FIG. 2 is a schematic diagram of a conversion of pixel channel values to buffer values during a content based video hashing process, according to an embodiment;

FIG. 3 is a schematic diagram of a conversion of pixel channel values to buffer values during a content based video hashing process, according to another embodiment;

FIG. 4 is a schematic diagram of generation of buffer distance values during a content based video hashing process, according to an embodiment;

FIG. 5 is a schematic diagram of an audio content-based video hashing process, according to an embodiment;

FIG. 6 is a schematic diagram depicting an audio hash and transcript generated during an audio content-based video hashing process, according to an embodiment;

FIG. 7 is a schematic diagram depicting the comparison of two audio hashes during an audio content-based video hashing process, according to an embodiment;

FIG. 8 is a schematic diagram depicting the comparison of two audio transcripts during an audio content-based video hashing process, according to an embodiment;

FIG. 9 is a flowchart of a method of content based video matching, according to an embodiment;

FIG. 10 is a flowchart of a method of content based video matching, according to another embodiment; and

FIG. 11 is a system block diagram of a computing device, according to an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

One or more systems described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, server, and personal computer, cloud-based program or system, laptop, personal data assistance, cellular telephone, smartphone, or tablet device.

Each program is preferably implemented in a high-level procedural or object-oriented programming and/or scripting language to communicate with a computer system. However, the programs can be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein.

A description of an embodiment with several components in communication with each other does not imply that all such components are required. On the contrary, a variety of optional components are described to illustrate the wide variety of possible embodiments of the present invention.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The following relates generally to a content based video hashing method, and more particularly to a video hashing method applying pixel binning for all pixels of all frames of a video file, as well as a comparison of computer generated video audio transcript data and audio loudness based binary hashing in some embodiments.

Frames may be extracted from a first video file, and each pixel channel value may be binned according to a pixel binning map, to produce buffer values. This process may be repeated with a second video file. Pixels may be binned as alphabetic characters. Once all pixels of each frame of the first and second videos have been converted to buffer values, buffer values of each corresponding pixel of each video may be compared, and a distance value between each corresponding pixel may be calculated. Distances may comprise the alphabetic distance between each buffer value. Once all distance values have been calculated, an average buffer distance value may be determined. This average value may be used to represent the similarity of the first and second videos, and accordingly, may be used to identify very similar videos (e.g., by comparing the average value to a predetermined similarity threshold).

In some embodiments, audio data may be extracted from a first and second video file, and be converted to an audio hash comprising binary loudness determinations across predetermined periods. The audio data may be converted to a transcript using a speech-to-text method. The transcript and audio hashes may be compared to determine an average binary and/or alphabetic distance between the audio hashes and transcripts of each respective video. The transcript distance value and audio hash may be averaged together. This average value may correspond to the similarity of the two videos, and accordingly, be used to identify very similar videos.

The methods described herein may provide particular advantages by matching video based on visual and auditory content, instead of file characteristics, which may vary. For example, if a video is saved to a different format, (e.g., MP4 to GIF), traditional file based hashing will not indicate the content of the video is the same, even though all that has changed is the storage format.

For example, a video with identical content has been converted to various different file formats. Because file formats are different, their respective MD5 and SHA1 hashes are different, as outlined below:
GIF: MD5 hash: e85c65f82454cb43f13ad4978cd0d249, SHA1 hash: 048bb2a007c6f11a26bcda52266d48ab58062d83.
MP4: MD5 hash: 679290c567371b9686de23705cac731a, SHA1 hash: 3ebc52db74aa273daf61d880e3e85a5310935ac7.
AVI: MD5 hash: 7810736c44d9a689468fd280e55b1613, SHA1 hash: 8035c38deffd8d0293b894468a5937bd989287d1.

These methods also allow for comparisons to be accurately conducted, even if the video has been change or altered, such as if part of the video has been blurred, or the audio has been changed.

These methods may be applied to digital forensics. Such robust automated video matching and comparison methods allow for the detection of harmful content (e.g. by comparing unknown videos to a hash database of known harmful videos). In such applications, human operators do not need to view mentally harmful content, while allowing for the detection of illegal content and/or otherwise harmful or sensitive content which may have been altered in same fashion to evade typical file hash based detection methods.

For example, according to some embodiments, a known illegal video and mentally harmful video may comprise a hash of ‘ABC’. If an examiner is looking reviewing the results of a harmful content scan, they may look for the hash ‘ABC’, and determine if the evidence contains the illegal video without having to view the sensitive video content.

Similarly, according to some embodiments, if an examiner reviews the results of the scan, and they find a video with the hash ‘ACC’, they may determine that the video is similar to the known illegal video, and that the middle portion of the video is different.

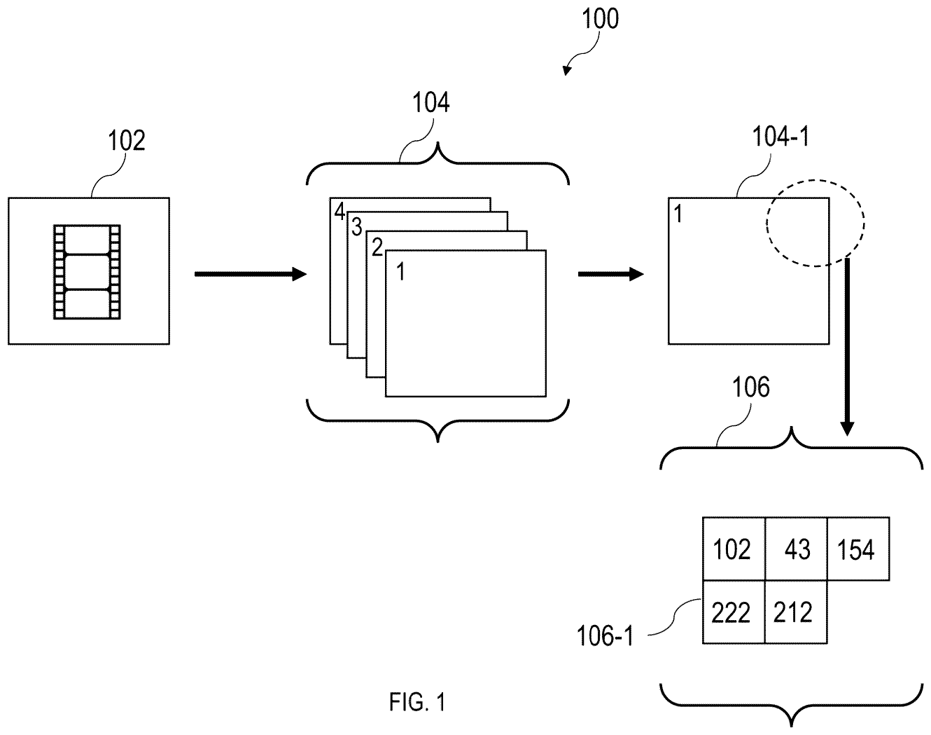

Referring now to FIG. 1, shown therein is a block diagram illustrating a content based video matching method 100, according to an embodiment.

The method 100 includes receiving a video file 102. Video file 102 may be any digital file that stores and conveys video information. For example, video file 102 may include uncompressed bitmap format video files, or compressed format videos, such as those compressed using H.264, H.265/HEVC, WebM, H.266, AV1, MPEG-2, WMV or any other compression scheme known in the art. Each video file 302 may comprise a fixed length in seconds and a fixed frame rate.

Video file 102 is converted into a plurality of video frames 104. Each frame may be extracted from video file 102 and stored as a still image file or data, on a storage disk or in memory. Each video file 102 comprises a fixed number of frames, according to some embodiments. While in FIG. 1, video file 102 is shown as comprising four frames (frames 1-4), a video file may comprise any number of frames.

An individual frame (e.g. frame 104-1) may be then processed on a pixel by pixel basis. Five pixels 106 have been illustrated in FIG. 1. Pixels 106 may comprise the pixels of the upper right corner of frame 104-1, as shown in FIG. 1. While five pixels are shown as an illustrative example, when applied to a video file, more or fewer pixels may be applied. For example, all pixels of a video frame, corresponding to the full resolution of the frame, may be 640×480, for a total sum of 307200 pixels.

Each individual pixel (e.g. pixel 106-1) may be associated with a pixel channel value, such as 222 for pixel 106-1. Video file 102 of FIG. 1 comprises single channel (e.g. monochrome) pixels, with 8 bit channel values ranging from 0 to 255, wherein lower values correspond to darker colors (e.g. 255 is pure white, while 0 is pure black). In other examples, each pixel may be associated with a plurality of channels (e.g. 3 separate RGB channels), and/or greater or different bit depths.

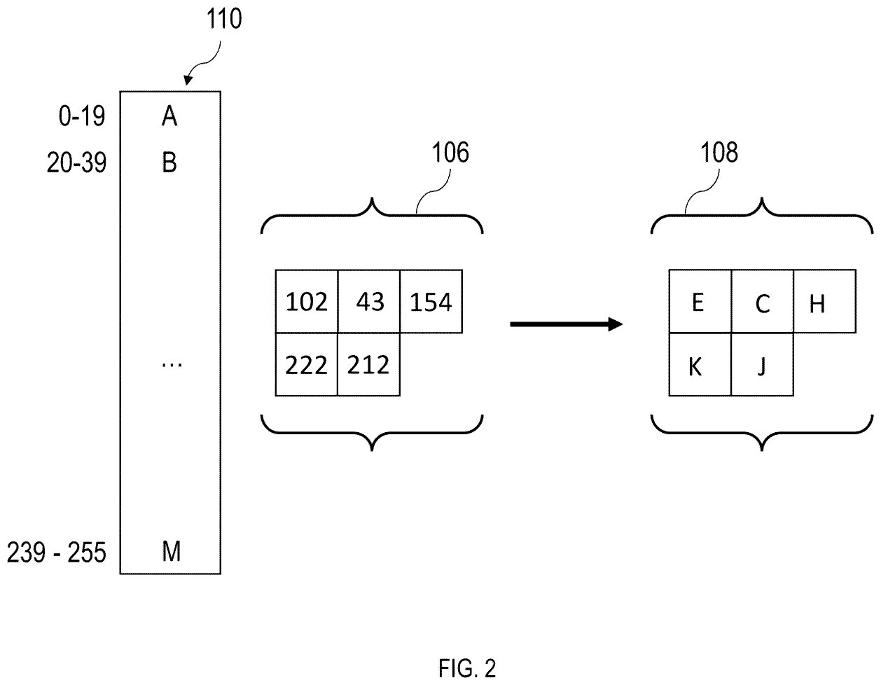

Referring now to FIG. 2, shown therein is a block diagram depiction of pixel channel values being converted to buffer channel vales, according to an embodiment. Shown therein is buffer scale 110, pixels 106, and buffer values 108.

Buffer scale 110 depicts a conversion scale of pixel channel values to buffer values. In the embodiment of FIG. 2, the buffer scale 110 includes the following ranges, with pixel channel values binned in 20 integer increments: A: 0-19, B: 20-39, C: 40-59, . . . , L: 220-239, and M: 240-255. By binning a range (e.g. 20) of pixel channel values to a single buffer value, the method may be more robust to slight alterations in video content. This is advantageous, as such small alterations may not be visible to a human operator, and accordingly, effectively convey the same content and/or information. For example, a value of 254 and 255 will both appear substantially white to a human operator.

In other examples, buffer scale 110 may differ. For example, the bit depth of a video may differ, and accordingly, a greater range of values may be required for a 12-bit video than an 8-bit video. Similarly, channel values may be binned in smaller or larger increments than 20, which may provide for greater or less video matching precision, at the cost or benefit of greater or less computing resource usage, respectively.

In some examples, channel values may be binned unequally. Pixel values at the extreme ranges (e.g. near 0 and 255) may comprise greater ranges (0-29), while pixel values within the middle of the scale may comprise smaller ranges (100-105). Such arrangements may provide for greater precision in some examples. In other examples, other unequal binning scales may be used.

The buffer scale may be used to convert pixel channel values to buffer values, as seen in FIG. 2. Pixels 106 are converted to buffer values 108, according to scale 110. Pixels 106 comprise the following channel values, indexed from the top left pixel, moving left to right, and top to bottom: 102, 43, 154, 222, and 212. These values correspond to the following buffer values, indexed in the same manner: E, C, H, K and J.

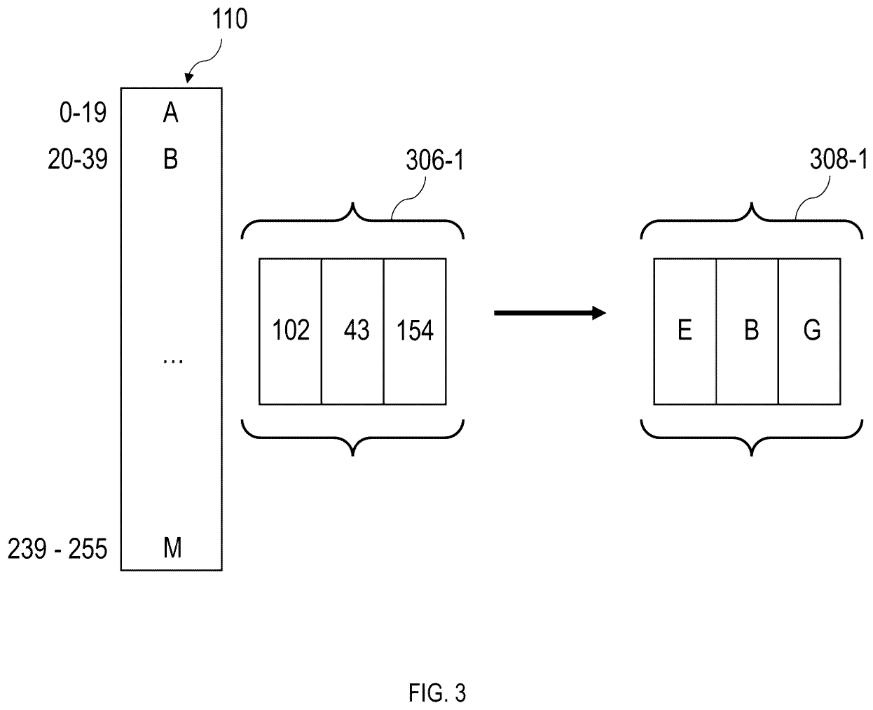

Referring now to FIG. 3, shown therein is an example embodiment wherein a single pixel 306-1 is converted to buffer values 308-1. Pixel 306-1 comprises a three channel, RGB, 8-bit pixel, having the following RGB channel values respectively: 102, 43, and 54. These channel values correspond to the following buffer values: E,B,G.

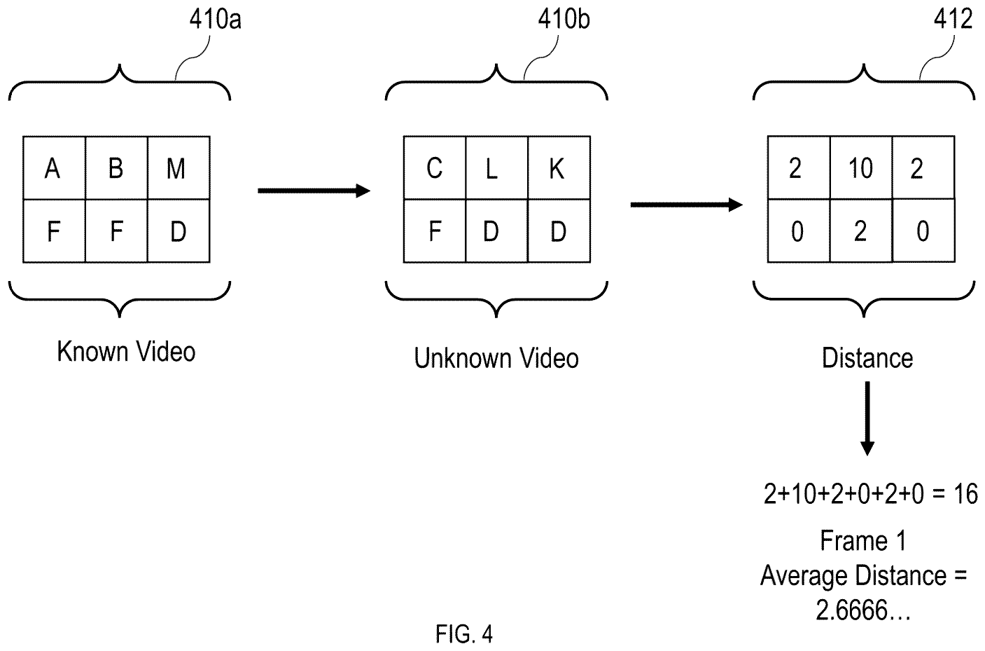

Referring now to FIG. 4, shown therein is a block diagram depicting a comparison of buffer values between two frames 410a, 410b, of a known video file and unknown video file, respectively. The alphabetic distance between the corresponding buffer values of frames 410a, 410b may be computed to produce buffer distance map 412. The buffer distance map 412 includes buffer distances of, indexed from the top left to bottom right, left to right, top to bottom: 2, 10, 2, 0, 2, and 0. These buffer distance values may be averaged to generate an overall average buffer distance for frame 410a and 410b. In the example of FIG. 4, the average buffer distance is approximately ˜2.667.

In some examples, a shorthand convention may be used to convey buffer channel values more compactly, reducing disk and/or memory size requirements. For example, a superscript notation may be used to denote repeated pixels, such as the following notation for 410a: ABMF\hat{ }2D, wherein “\hat{ }2” conveys two repeated pixels. In other examples, such as examples similar to those of FIG. 3, wherein each pixel comprises three color channels, such a notation may be used on a per pixel basis. For example, such a pixel may comprise channel values of 255, 255 and 255, corresponding to buffer values of N, N and N. If a neighboring pixel comprises identical buffer values, this may be conveyed as NNN\hat{ }2. If a frame is entirely white, having a number of pixels totaling 2073600 (e.g. 1080p resolution), the entire frame may be described as “NNN\hat{ }2073600”, instead of individually addressing each pixel.

This process above described in reference to FIGS. 1 to 4, may be repeated for all frames of a first known video file to produce buffer values for all pixels of all frames. Similarly, this process may be conducted on a second, suspected matching video file. For example, a known video may be converted into a plurality of frames and converted to buffer values for all pixels of all frames of the second video file.

Average buffer distance values between each frame of the first and second video may be calculated. Further, an overall buffer distance (e.g., the average of all average buffer distance values of each frame) may be calculated, producing a single overall buffer distance value between the two video files. A threshold overall buffer distance value may be set, referenced or pre-determined to which the overall buffer distance value may be compared. If the overall buffer distance value is less than the threshold value, the first video and second video are deemed to match. If the overall buffer distance value is greater than the threshold value, the first video and second video are deemed a non-match.

In some examples, a less intensive file-based hash method (e.g., MD5 hashing) may first be performed to determine if two files are perfect matches (i.e., hash matches). If two files are hash matches, the content hashing method of the present disclosure may be skipped. This may advantageously reduce computing requirements, which can be particularly valuable in digital forensics applications where voluminous sets of data may be analyzed. If there is no hash match, the content-based video hashing method described above may then be performed.

In some examples, the number or percentage of matching buffer values may be compared instead of comparing the average overall buffer distance value. This process may be conducted on a frame-by-frame basis, or on the overall video.

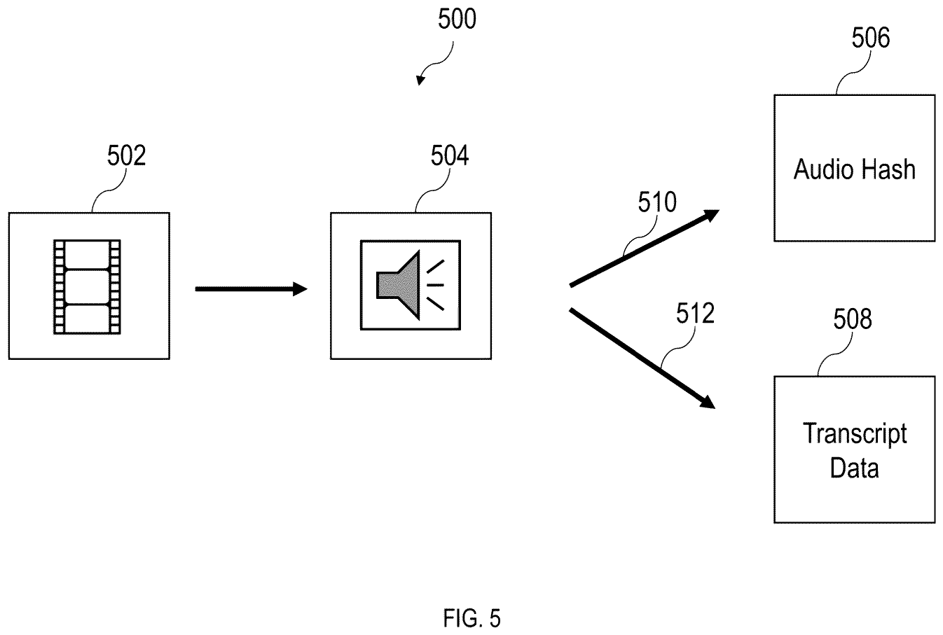

Referring now to FIG. 5, shown therein is a block diagram showing an audio based content based video hashing method 500, according to an embodiment. The block diagram depicts a video file 502, audio 504 extracted from video file 502, audio hash 506, and transcript data 508.

Video file 502 may comprise any digital file that stores and conveys video information. For example, video file 502 may include uncompressed bitmap format video files, or compressed format videos, such as those compressed using H.264, H.265/HEVC, WebM, H.266, AV1, MPEG-2, WMV or any other compression scheme known in the art. Each video file 502 may comprise a fixed length in seconds, and a fixed frame rate.

Audio 504 is extracted from video file 502 and includes the audio track of video file 502. Audio 504 is preferably extracted from video 502 without any further processing, resample, or compression.

Transcript data 508 includes a text transcript of the audio 504 of video 502. In some examples, the method of FIG. 5 may only be performed on video including human speech, vocals or dialogue, which may be converted to a text transcript. For example, if audio 504 comprises instrumental music, transcript data 508 may not be generated. In some examples, the generation of transcript data 508 may indicate that a video 502 does not include human speech, vocals or dialogue.

Transcript data 508 may be generated using an audio-to-text transcription process 512. Transcription process 512 may include the application of a speech recognition model to audio 504 to output transcript data 508. In some examples, a commercial speech recognition service, such as Amazon Transcribe, or Google Cloud Speech-to-Text may be applied to generate transcript data 508.

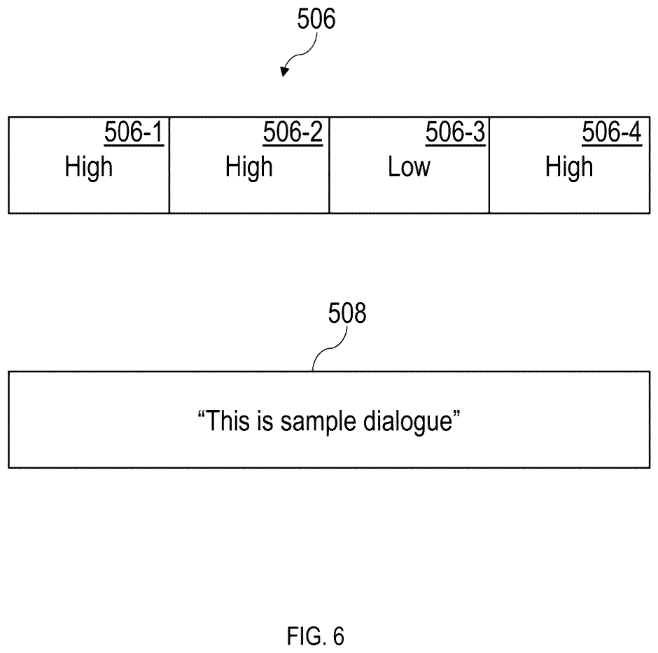

Referring now to FIG. 6, shown therein is a block diagram detailing an audio hash 506 and transcript data 508 of a video 502, according to an embodiment.

Audio hash 506 may be generated through a hashing process (510 in FIG. 5). In some examples, audio hash 506 may include a binary determination of loudness of the audio 504. For example, at a certain first point in time, audio 504 may be silent, while at a certain second point in time, audio 504 may include a loud noise. Audio 504 may be periodically sampled for loudness to determine a loudness for each sample. For example, audio hash 506 includes four samples: 506-1, 506-2, 506-3 and 506-4. Samples having a loudness above a threshold value may be deemed to be “high” and assigned a value of “1”, and samples having a loudness below a threshold value may be deemed to be “low” and assigned a value of “0”, or some other indicator of low volume. In some examples, loudness for each period may include an average loudness across an entire period, or an instantaneous determination of loudness.

In other examples, loudness may be measured with greater granularity than a binary determination, such as eight different audio levels.

In some examples, a waveform of audio 504 may be extracted to generate audio hash 506.

In some examples, hash 506 sampling periods may correspond to frames of video 502, some other period (e.g. every one second), or the native sampling rate of the audio 504.

Transcript data 508 includes the following text: “This is sample dialogue”.

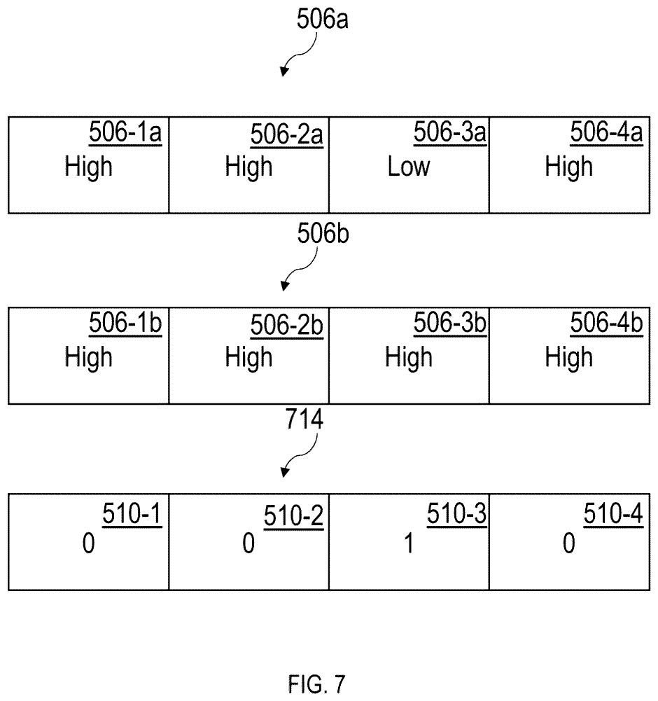

Referring now to FIG. 7, shown therein is a block diagram showing a comparison of two audio hashes, 506a and 506b, as well as a hash comparison map 714, according to an embodiment.

Hashes 506a and 506b may be hashes from a known video and unknown video, respectively. Hash 506a includes four samples, “High”, “High”, “Low” and “High”, and 506b comprises four samples, “High”, “High”, “High” and “High”.

Hashes 506a and 506b are compared, generating a comparison map 714. Comparison map 714 may include a binary value for each sample, wherein a value of 1 corresponds to a non-matching sample and a value of 0 corresponds to a matching sample (or vice versa). Map 714 includes binary values of 0, 0, 1 and 0. The comparison map 514 may be further processed to generate an average audio hash distance value. For example, in FIG. 7, this value may be 0.25 ((0+0+1+0)/4).

This average audio hash distance value corresponds to the similarity of the audio tracks of the video files being compared, wherein smaller values correspond to more similar audio data (similarly, a scheme may be implemented where higher values correspond to more similar audio data). The average audio hash distance value may be compared to a predetermined threshold value. Average audio hash distance values less than the threshold value may be deemed matches, while average audio hash distance values greater than the threshold value may be deemed non-matches.

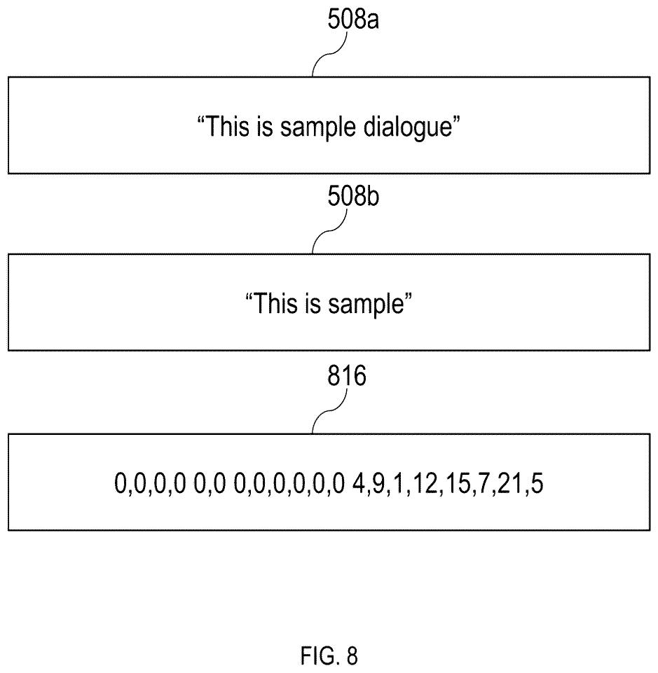

Referring now to FIG. 8, shown therein is a block diagram showing a comparison of two transcripts, 508a and 508b, and comparison map 516, according to an embodiment. Transcript 508a includes the following text: “This is sample dialogue”. Transcript 508b includes the following text: “This is sample”.

Transcripts 508a and 508b may be compared on a character-by-character basis to generate comparison map 816. Comparison map 816 includes an alphabetic distance between characters of transcripts 508a and 508b. Transcripts 508a and 508b differ by the presence of the word “dialogue” in transcript 508a. Accordingly, map 816 includes twelve zeros, followed by the distance between a null value and the characters comprising the word “dialogue”: 4, 9, 1, 12, 15, 7, 21 and 5.

Comparison map 816 may be further processed to generate an average transcript distance value. In the example of FIG. 8, this distance equals (0*12+9+1+12+15+7+21+5)/19=70/19=˜3.684. This average transcript distance value corresponds to the similarity of the transcripts 508a, 508b, wherein smaller values correspond to more similar transcript data (similarly a scheme may be implemented in which larger values correspond to more similar transcript data). The transcript distance may be compared to a predetermined threshold value. Transcript distance values less than the threshold value may be deemed matches, while transcript distance values greater than the threshold value may correspond to videos may be deemed non-matches.

According to some embodiments, the transcript distance value and audio hash distance may be averaged, or otherwise combined, to generate an overall audio distance value incorporating information originating from both the audio hash and transcript comparison. Such combinations may result in hashing methods with greater precision. Such overall audio distance value may be compared to a predetermined threshold (similar to how the transcript and audio hash distance values may be compared to respective thresholds) to determine whether the videos being compared are deemed a match or non-match.

According to some embodiments, the methods of FIGS. 1 to 4 and FIGS. 5 to 8 may be combined, such that both video and audio content of a video file is used to perform content-based hashing. For example, similarity values for the visual and audio portions of a video may be averaged to generate an overall similarity value. Such a combination may provide for greater hashing precision.

The methods described above may be applied to match unknown video content to a database of known video content (e.g., one or more known video files). The full database of known video content may be hashed using one or more of the example methods described here, producing a hash database, which may then be stored. The same hashing method may be applied to an unknown video. The hash of this unknown video may be cross referenced against the hash database. The hash comparison may be used to determine whether the unknown video is substantially similar to any video within the video database. Such a method may be robust to attempts to thwart typical file based hashing methods.

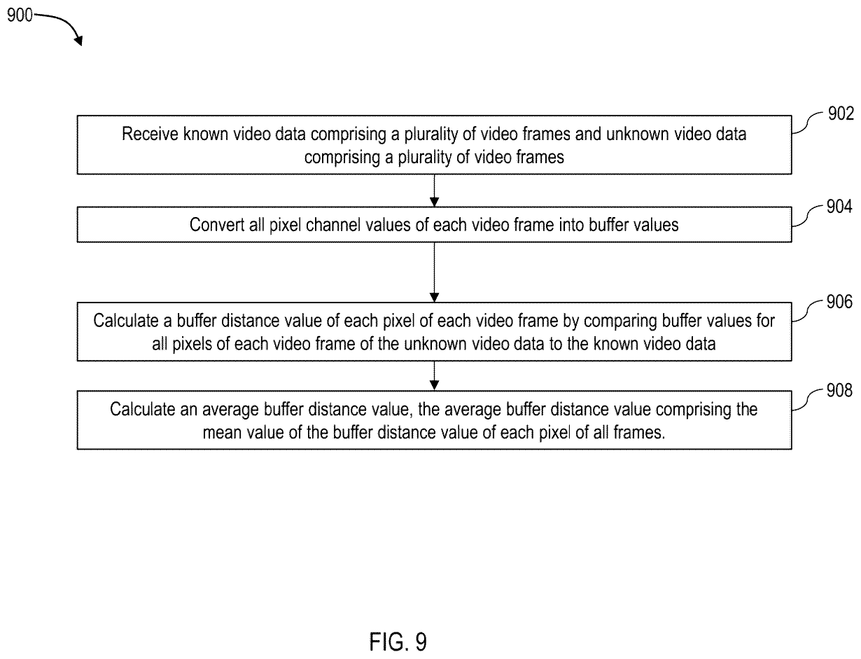

Referring now to FIG. 9, shown therein is a flow chart of a method 900 of image-based video content hashing, according to an embodiment. Method 900 includes steps 902, 904, 906, and 908. Method 900 is conducted by a computing device, such as device 1000 of FIG. 1.

At 902, known video data comprising a plurality of video frames and unknown video data comprising a plurality of video frames is received.

At 904, all pixel channel values of each video frame of the unknown video data and known video data are converted into buffer values.

At 906, a buffer distance value of each pixel of each video frame is calculated by comparing buffer values for all pixels of each video frame of the unknown video data to the known video data.

At 908, an average buffer distance value is calculated, the average buffer distance value comprising the mean value of the buffer distance value of each pixel of all frames.

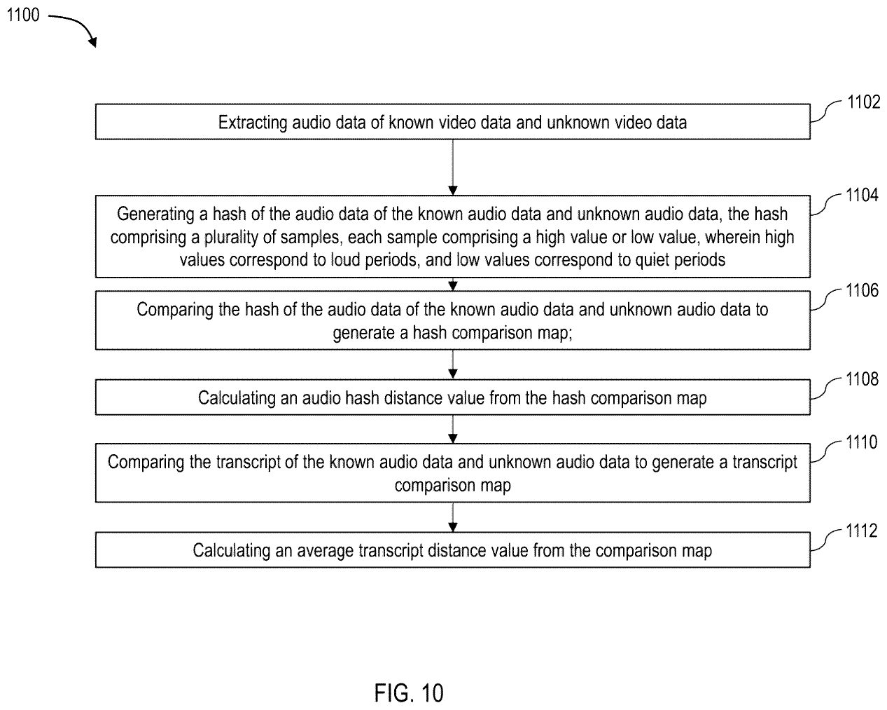

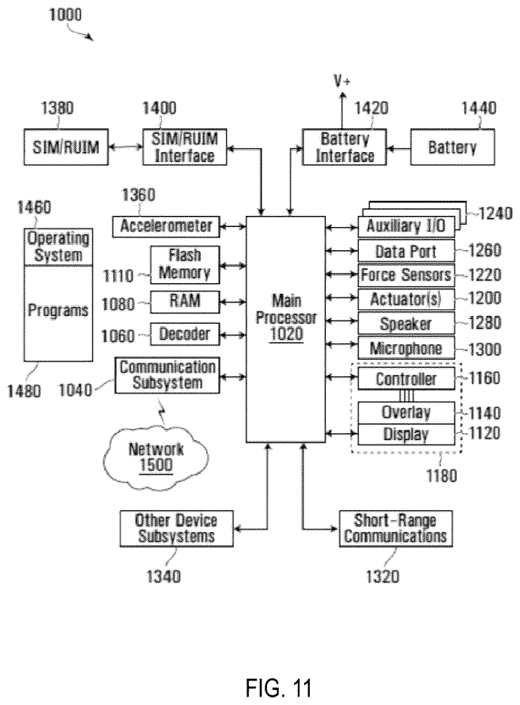

Referring now to FIG. 10, shown therein a flow chart of a method 1100 audio-based video content hashing, according to an embodiment. Method 1100 includes steps 1102, 1104, 1106, 1108, 1112 and 1114. Method 1100 is conducted by a computing device, such as device 1000 of FIG. 11.

At 1102, audio data of known video data and unknown video data is extracted.

At 1104, a hash of the known audio data and a hash of the unknown audio data is generated, each hash comprising a plurality of samples, each sample comprising a high value or low value, wherein high values correspond to loud periods and low values correspond to quiet periods.

At 1106, the hash of the known audio data and the hash of the unknown audio data is compared to generate a hash comparison map.

At 1108, an audio hash distance value is calculated from the hash comparison map.

At 1110, a transcript of the known audio data and a transcript of the unknown audio data is compared to generate a transcript comparison map.

At 1112, an average transcript distance value from the comparison map is calculated using the transcript comparison map.

Referring now to FIG. 11, shown therein is a block diagram of a computing device 1000, according to an embodiment. The computing device 1000 may be used to execute the method of video comparison using content-based hashing described herein.

The computing device 1000 includes multiple components such as a processor 1020 that controls the operations of the computing device 1000. Communication functions, including data communications, voice communications, or both may be performed through a communication subsystem 1040. Data received by the computing device 1000 may be decompressed and decrypted by a decoder 1060. The communication subsystem 1040 may receive messages from and send messages to a wireless network 1500.

The wireless network 1500 may be any type of wireless network, including, but not limited to, data-centric wireless networks, voice-centric wireless networks, and dual-mode networks that support both voice and data communications.

The computing device 1000 may be a battery-powered device and as shown includes a battery interface 1420 for receiving one or more rechargeable batteries 1440.

The processor 1020 also interacts with additional subsystems such as a Random Access Memory (RAM) 1080, a flash memory 1100, a display 1120 (e.g. with a touch-sensitive overlay 1140 connected to an electronic controller 1160 that together comprise a touch-sensitive display 1180), an actuator assembly 1200, one or more optional force sensors 1220, an auxiliary input/output (I/O) subsystem 1240, a data port 1260, a speaker 1280, a microphone 1300, short-range communications systems 1320 and other device subsystems 1340.

In some embodiments, user-interaction with the graphical user interface may be performed through the touch-sensitive overlay 1140. The processor 1020 may interact with the touch-sensitive overlay 1140 via the electronic controller 1160. Information, such as text, characters, symbols, images, icons, and other items that may be displayed or rendered on a computing device generated by the processor 102 may be displayed on the touch-sensitive display 118.

The processor 1020 may also interact with an accelerometer 1360 as shown in FIG. 1. The accelerometer 1360 may be utilized for detecting direction of gravitational forces or gravity-induced reaction forces.

To identify a subscriber for network access according to the present embodiment, the computing device 1000 may use a Subscriber Identity Module or a Removable User Identity Module (SIM/RUIM) card 1380 inserted into a SIM/RUIM interface 1400 for communication with a network (such as the wireless network 1500). Alternatively, user identification information may be programmed into the flash memory 1100 or performed using other techniques.

The computing device 1000 also includes an operating system 1460 and software components 1480 that are executed by the processor 1020 and which may be stored in a persistent data storage device such as the flash memory 1100. Additional applications may be loaded onto the computing device 1000 through the wireless network 1500, the auxiliary I/O subsystem 1240, the data port 1260, the short-range communications subsystem 1320, or any other suitable device subsystem 1340.

In use, a received signal such as a text message, an e-mail message, web page download, or other data may be processed by the communication subsystem 1040 and input to the processor 1020. The processor 1020 then processes the received signal for output to the display 1120 or alternatively to the auxiliary I/O subsystem 1240. A subscriber may also compose data items, such as e-mail messages, for example, which may be transmitted over the wireless network 1500 through the communication subsystem 1040.

For voice communications, the overall operation of the computing device 1000 may be similar. The speaker 1280 may output audible information converted from electrical signals, and the microphone 1300 may convert audible information into electrical signals for processing.

While the above description provides examples of one or more apparatus, methods, or systems, it will be appreciated that other apparatus, methods, or systems may be within the scope of the claims as interpreted by one of skill in the art.

1. A video matching method, the method comprising:
receiving known video data comprising a first plurality of video frames and unknown video data comprising a second plurality of video frames;
converting all pixel channel values of each video frame into buffer values;
calculating a buffer distance value of each pixel of each video frame by comparing buffer values for all pixels of each video frame of the unknown video data to the known video data; and
calculating an average buffer distance value, the average buffer distance value comprising the mean value of the buffer distance value of each pixel of all frames.

2. The method of claim 1, further comprising comparing the average buffer distance value to a distance threshold to generate a video similarity value and using the video similarity value to determine whether the known and unknown videos are deemed to match.

3. The method of claim 1, further comprising comparing a set of matching buffer values to a distance threshold to generate a video similarity value and using the video similarity value to determine whether the known and unknown videos are deemed to match.

4. The method of claim 1, further comprising comparing a percentage of matching buffer values to a distance threshold to generate a video similarity value and using the video similarity value to determine whether the known and unknown videos are deemed to match.

5. The method of claim 1, further comprising calculating a number of matching pixel buffer values for each frame.

6. The method of claim 5, further comprising calculating a mean number of matching pixel buffer values across all frames.

7. The method of claim 2, wherein when the average video distance value is less than a threshold buffer distance, the known video data and unknown video data are deemed to match.

8. A video matching method, the method comprising:
extracting first audio data of known video data and second audio data of unknown video data;
generating a first hash of the first audio data and a second hash of the second audio data, each of the first and second hashes comprising a plurality of samples, each sample comprising a high value or low value, wherein high values correspond to loud periods, and low values correspond to quiet periods;
comparing the first and second hashes to generate a hash comparison map;
calculating an audio hash distance value from the hash comparison map;
applying a speech to text algorithm to each of the first audio data and the second audio data to generate a transcript of the first audio data and the second audio data, respectively;
comparing the transcript of the first audio data and the transcript of the second audio data to generate a transcript comparison map; and
calculating an average transcript distance value from the transcript comparison map.

9. The method of claim 8, further comprising averaging the average transcript distance value and the average buffer distance value to generate an overall similarity value.

10. The method of claim 8, wherein a file-based hash method is used to generate the first hash and the second hash to determine a match between the first audio data and the second audio data.

11. A computer system for video matching, comprising:
at least one processor configured to:
receive known video data comprising a first plurality of video frames and unknown video data comprising a second plurality of video frames;
convert all pixel channel values of each video frame into buffer values;
calculate a buffer distance value of each pixel of each video frame by comparing buffer values for all pixels of each video frame of the unknown video data to the known video data; and
calculate an average buffer distance value, the average buffer distance value comprising the mean value of the buffer distance value of each pixel of all frames.

12. The system of claim 11, wherein the at least one processor is further configured to compare the average buffer distance value to a distance threshold to generate a video similarity value and use the video similarity value to determine whether the known and unknown videos are deemed to match.

13. The system of claim 11, wherein the at least one processor is further configured to compare a set of matching buffer values to a distance threshold to generate a video similarity value and use the video similarity value to determine whether the known and unknown videos are deemed to match.

14. The system of claim 11, wherein the at least one processor is further configured to compare a percentage of matching buffer values to a distance threshold to generate a video similarity value and use the video similarity value to determine whether the known and unknown videos are deemed to match.

15. The system of claim 11, wherein the at least one processor is further configured to calculate a number of matching pixel buffer values for each frame.

16. The system of claim 15, wherein the at least one processor is further configured to calculate a mean number of matching pixel buffer values across all frames.

17. The system of claim 12, wherein when the average video distance value is less than a threshold buffer distance, the known video data and unknown video data are deemed to match.

18. A computer system for video matching, comprising:
at least one processor configured to:
extract first audio data of known video data and second audio data of unknown video data;
generate a first hash of the first audio data and a second hash of the second audio data, each of the first and second hashes comprising a plurality of samples, each sample comprising a high value or low value, wherein high values correspond to loud periods, and low values correspond to quiet periods;
compare the first and second hashes to generate a hash comparison map;
calculate an audio hash distance value from the hash comparison map;
apply a speech to text algorithm to each of the first audio data and the second audio data to generate a transcript of the first audio data and the second audio data, respectively;
compare the transcript of the first audio data and the transcript of the second audio data to generate a transcript comparison map; and
calculate an average transcript distance value from the transcript comparison map.

19. The system of claim 18, wherein the at least one processor is further configured to method average the average transcript distance value and the average buffer distance value to generate an overall similarity value.

20. The system of claim 18, wherein the at least one processor is further configured to use a file-based hash method to generate the first hash and the second hash to determine a match between the first audio data and the second audio data.
